(19) United States
(12) Patent Application Publication
(10) Pub. No.: US 2026/0085610 A1
(43) Pub. Date: Mar. 26, 2026

(54) A DISPLACEMENT MEASURING DEVICE FOR INSTALLATION IN A ROCK HOLE

(71) Applicant: INNOVATIVE MINING PRODUCTS (PTY) LTD, Johannesburg (ZA)

(72) Inventors: Rual ABREU, Johannesburg (ZA); Paolo PASTORINO, Queensland (AU); Greig KNOX, Johannesburg (ZA)

(21) Appl. No.: 19/112,780

(22) PCT Filed: Sep. 11, 2023
(86) PCT No.: PCT/ZA2023/050055

§ 371 Date: Mar. 18, 2025

(30) Foreign Application Priority Data
Sep. 20, 2022 (ZA) 2022/09801

(51) Int. Cl. E21D 21/02; E21D 21/00; G01B 11/16

(52) U.S. Cl. CPC E21D 21/02; E21D 21/0053; G01B 11/16

(57) ABSTRACT

The invention provides a displacement measuring device which includes an elongate rigid body which extends between a proximal end and a distal end and which is adapted for insertion in a rock hole, the body including a first member and a second member, a proximal anchor engaged with the first member and positioned and adapted to engage the rock hole at a proximal location, a distal anchor engaged with the second member and positioned and adapted to engage the rock hole at a distal location, and a displacement sensor, wherein the first member is adapted to move axially relatively to the second member when the proximal location moves away from the distal location, as a result of a displacement, and wherein the displacement sensor is responsive to movement of the first member relatively to the second member and which is adapted to generate a first output which is indicative of the extent of the displacement.

### FIELD OF THE INVENTION

The invention relates to a device which measures displacement, or measures displacement and the locality of that deformation, of the rock mass surrounding a rock hole in which the device is installed.

### BACKGROUND OF THE INVENTION

To enhance mine safety, it is crucial to assess the structural integrity of rock wall support systems, including the installation of rock bolt reinforcements.

Passive and dynamic forces exerted by the surrounding rock mass subject rock bolts to strain, and failure may occur when this strain exceeds the bolt's capacity. It is advantageous to monitor the deformation within the rock mass surrounding rock bolt installations as an indicator of strain, providing early warnings when strain approaches a critical threshold. Measuring deformation or strain in the rock mass is a vital safety measure in mining applications.

Several underground devices are available for measuring rock mass deformation and recording data for analysis by mine operators. Typically, these devices require a separate installation process, distinct from daily mining operations like ground support installation. This separation results from the instruments lacking the robustness and compatibility necessary for installation by standard mining equipment. Moreover, some device installations demand specialized technical personnel, such as geotechnical engineers.

Consequently, these devices are often installed as secondary processes after standard operations are completed. This necessitates separate planning and allocation of resources (personnel, equipment, and consumables) for their installation, diverting resources from regular mining activities and causing interruptions in the mining cycle, ultimately leading to production and revenue losses.

The present invention at least partially addresses the aforementioned problem.

### SUMMARY OF INVENTION

Hereinafter, the change in position of the proximal location relatively to the distal location is referred to as displacement.

In the context of the invention, a displacement occurs when a section of the rock hole, to which the first anchoring member is engaged to, moves relatively to a section of the rock hole, to which the second anchoring member engages.

Hereinafter “sensor” refers to a device that responds to a physical stimulus (such as heat, light, sound, pressure, magnetism, or a particular motion) and transmits a resulting signal (as for measurement or operating a control).

The invention provides a displacement measuring device which includes an elongate rigid body which extends between a proximal end and a distal end and which is adapted for insertion in a rock hole, the body including a first member and a second member, a proximal anchor engaged with the first member and positioned and adapted to engage the rock hole at a proximal location, a distal anchor engaged with the second member and positioned and adapted to engage the rock hole at a distal location, and a displacement sensor, wherein the first member is adapted to move axially relatively to the second member when the proximal location moves away from the distal location, as a result of a displacement, and wherein the displacement sensor is responsive to movement of the first member relatively to the second member and which is adapted to generate a first output which is indicative of the extent of the displacement.

The first member may be directly engaged to the second member.

The first and second members may be telescopically inter-engaged.

The first member or, alternatively, the second member may include a cylinder with a bore.

The second member or, alternatively, the first member may include a shaft which engages with the bore.

Alternatively, the first member and the second member are not directly engaged.

In this alternative, the device may include at least one sleeve which connects the first and second members.

The sleeve may contain, at least partially, the first and second members.

The sleeve may be a cylindrical sleeve which includes a plurality of slots longitudinally spaced from one another.

In this alternative, the first member may include a guide rod to which the proximal anchor engages.

The device includes a plurality of spaced intermediate anchor elements mounted on the guide rod, each anchor element positioned to penetrate the sleeve through a respective slot, to engage the rock hole in use, and each anchor element adapted to move relatively to the guide rod, within its slot.

Additionally, the device may include at least one location sensor fixedly engaged with the guide rod to move relatively to the anchor elements.

The at least one location sensor may be responsive to the relative distance between it and the adjacent anchor elements.

The at least one location sensor may be adapted to generate a second output which is indicative of a locality of the displacement In this alternative, the first member is adapted to move axially away from the second member when there is rock separation between the proximal location and the distal location.

In a further alternative, the device may include a first sleeve and a second sleeve, wherein the first sleeve contains, at least partially, the first member, and wherein the second sleeve contains, at least partially, the second member.

In this alternative, the sleeves do not have slots and are adapted to hold the proximal anchor and the distal anchor, respectively, in an inactive contained position.

The first and second sleeves may move relative to their respective first and second members, enabling the first and second anchors to reconfigure from the contained position to an expanded position.

The sensor, either a displacement sensor or a location sensor, may be a device which detects displacement between a sensing element and a target by measuring a parameter change as a measure of distance or location

The sensor may be, for example, a resistive or capacitive potentiometer, a linear encoder, a string potentiometer, an optical or infrared sensor, a time-of-flight sensor, an ultrasonic sensor, or a hybrid sensor, for example, a spring elongating against a load cell or a magnetic-resistive potentiometer displacement sensor.

Preferably, the displacement sensor and the location sensor are optical sensors.

The optical sensor may be located on the either the first member or the second member, with a reference or target correspondingly located on either the second member or first member.

The distal anchor may be positioned at or adjacent the distal end and the proximal anchor may be located closer to the proximal end.

The proximal and distal anchors may be adapted secure the first member or the second member at the proximal and distal locations, respectively.

The proximal anchor and distal anchor may be a static or an active, mechanically actuable, anchor.

The anchor elements may be static anchors.

The displacement measuring device may include a processing module which is in communication with the displacement sensor, and which receives the first output to calculate the extent of the displacement.

Furthermore, the processing module may be in communication with the location sensor to receive the second output to determine the locality of the displacement.

The first member may include a housing. Preferably, the housing includes the proximal end.

The processing module, and a battery, may be contained in the housing.

The displacement measuring device may include an indicator which is in communication with the processing module, and which is caused to emit a signal in response to the displacement exceeding a predefined limit.

The indicator may be located at the proximal end.

The displacement measuring device may include an activation mechanism which initiates the sensor to start responding to the displacement.

The activation mechanism may include a first moveable part, which includes a reference element, which engages the housing, and a switch contained with the housing, and which is in communication with the processing module.

Preferably, the reference element is a magnet, and the switch is a magnetic switch.

The first moveable part may be adapted to contain the reference element, and to resiliently engage the housing and to slide off the housing as a result of the displacement.

The first moveable part may be a circular or semi-circular casing.

For mechanical installation, the proximal end may be adapted for engagement or connection with a drill rig rock drill or other specialised bolting equipment.

The invention provides a displacement measuring and displacement locating device which includes an elongate rigid body which extends between a proximal end and a distal end and which is adapted for insertion in a rock hole, the body including cylindrical sleeve having a first pair of slots and a second pair of slots longitudinally spaced from the first pair, a guide rod within, and connected to, the sleeve and having a proximal anchor which is positioned to engage the rock hole at a proximal location, a distally locating element having a distal anchor which is positioned to engage the rock hole at a distal location; a first sliding member and a second sliding member mounted on the guide rod, located within the sleeve and adapted to move reciprocally therein along the guide rod, a first and a second intermediate anchor engaged to the first and the second sliding guide respectively and which penetrate the sleeve through the first pair of slots and the second pair of slots respectively to engage the rock hole at a first intermediate and a second intermediate location respectively, and a first sensor and a second sensor on the guide rod between an end of the guide rod and the first sliding member and between the first sliding member and the second sliding member respectively, wherein the guide rod and the sleeve are configured to move axially away from the distally locating element when there is rock separation (displacement) between the proximal location and the distal location, wherein the first sensor is responsive to movement of the guide rod relatively to the distally locating element and which is adapted to generate a first output which is indicative of the extent of the displacement, and wherein the second sensor is responsive to the relative distance between it and the first and second sliding members and which is adapted to generate a second output which is indicative of the locality of the displacement.

### BRIEF DESCRIPTION OF THE DRAWINGS

The invention is further described by way of examples with reference to the accompanying drawings in which:

FIG. 1 is a view in elevation of a displacement measuring device, in accordance with a first embodiment of the invention;

FIG. 1.1 is a view in cross-section through line x-x on FIG. 1;

FIG. 1A diagrammatically illustrates a section of the device of FIG. 1, with focus on the position of a sensor and its target, relatively to the body of the device;

FIG. 1B diagrammatically illustrates a section of a first variant of the device of FIG. 1, with focus on the position of a sensor and its target, relatively to the body of the device;

FIG. 1C diagrammatically illustrates a section of a third variant of the device of FIG. 1, with focus on the position of a sensor and its target, relatively to the body of the device;

FIG. 1D diagrammatically illustrates a section of a fourth variant of the device of FIG. 1, with focus on the position of a sensor of a second type and its target, relatively to the body of the device;

FIGS. 2 to 8 sequentially illustrate the installation into a rock hole of the device of FIG. 1;

FIG. 9 is a view in elevation of the device as illustrated partially and diagrammatically in FIG. 1C;

FIG. 10 is a view in elevation of a displacement measuring device, in accordance with a second embodiment of the invention;

FIGS. 11 to 16 sequentially illustrate the installation into a rock hole of the device of FIG. 10;

FIGS. 17 and 18 are views in elevation of a displacement measuring device, in accordance with a fourth embodiment of the invention, in a pre-displacement configuration;

FIGS. 19 and 20 are views in elevation of the device of FIG. 17 or 18, turned through 90°;

FIGS. 21 and 22 are views in elevation of a device of FIG. 17 or 18, in a post-displacement configuration;

FIGS. 23 and 24 are views in elevation of the device of FIG. 21 or 22, turned through 90°;

FIG. 25 to 28 are views in longitudinal section of the device of FIG. 21 or 22, illustrating configuration differences in the device when displacement of rock mass around the rock hole in which the device is deployed occurs at different localities; and

FIGS. 29 to 32 diagrammatically highlight the respective configuration differences illustrated in FIGS. 25 to 28.

### DESCRIPTION OF PREFERRED EMBODIMENTS

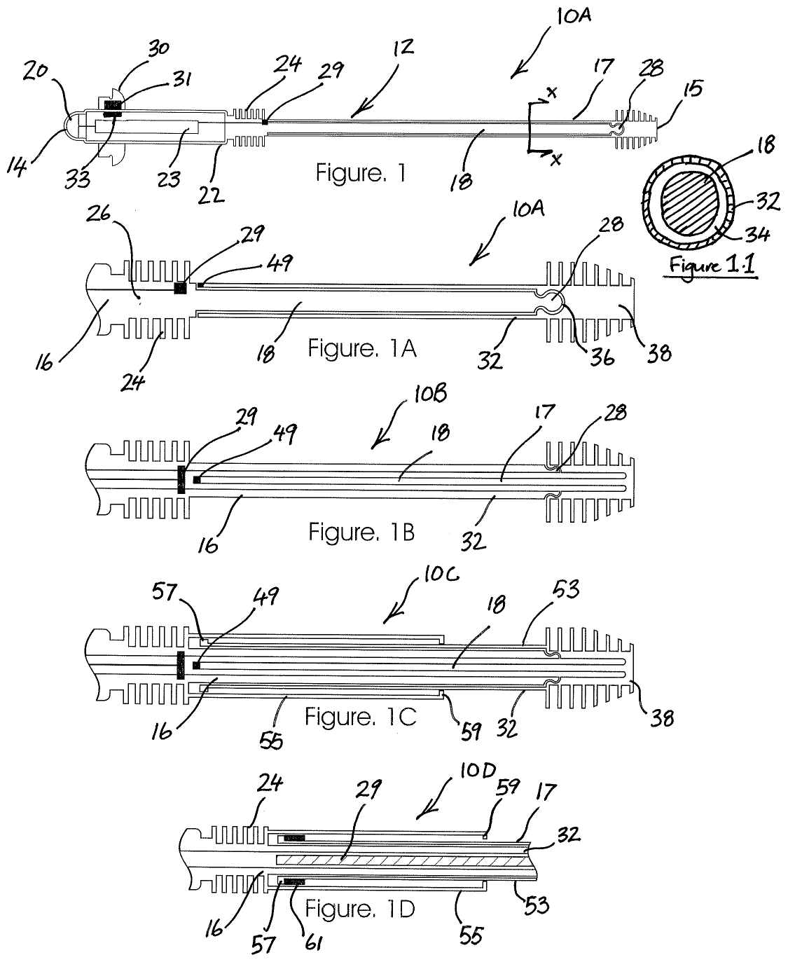

FIGS. 1, 1A and FIGS. 2 to 8 illustrate a displacement measuring device 10A in accordance with a first embodiment. The device is adapted to measure displacement or deformation of a rock mass surrounding a rock hole in which the device is installed.

With particular reference to FIG. 1, the device 10A includes a rigid elongate body 12 which extends between a proximal end 14 and a distal end 15.

The distal end 15 is shaped and configured to engage a drill rig rock drill or other specialised bolting equipment for insertion in a rock hole 19.

The body 12 includes a first member 16 and a second member 17.

In this embodiment, the first member 16 includes a shaft 18, an indicator 20 (and/or transmitter), at the proximal end 14, and a housing 22 interposed between the shaft and the indicator.

The housing 22 contains a processing module and battery pack 23. The processing module is in electronic communication with the indicator.

The shaft 18 has a resistive, resiliently deformable, static anchor 24 located on a collar portion 26 of the shaft. At a free end, the shaft has an interfacing pin 28 to keep the first member attached to the second member during transport, handling, and installation.

A sensor 29, which in this example is an optical sensor, is engaged with the first member. The sensor, processing module/battery 23 and indicator 20 hereinafter are collectively referred to as the sensor system.

A magnetic activation ring 30 circumscribes the housing 22 at an activation position. The activation ring contains a trigger magnet 31 which triggers a magnetic switch 33 from “off” to “on”

The second member 17 includes a tubular section 32 which has a bore 34 (see FIG. 1.1) into which the shaft penetrates. The bore has a blind end 36. Prior to activation, the interfacing pin 28 of the free end of the shaft, is engaged with the complementarily shaped blind end.

At the distal end 15, a second resistive, resiliently deformable, static anchor 38 is located on the second member.

FIG. 2 illustrates the device 10A engaged with an installation tool 40. The installation tool has an aperture 42 which is complementary to the proximal end of the body 12 of the device and which adapts a rock drill 44 of a mechanised installation machine, such as a drill rig (not shown), to connect with the device.

Once the device 10A is engaged, the rock drill 44 positions the device at the mouth of the rock hole 19 and, applying an axially directed force, pushes the device 10A into the rock hole. This action is illustrated in FIGS. 3 and 4.

In FIG. 5, the device 10A has been inserted to an installation depth. During this action, the activation ring 30 is pushed away from the underlying switch 30, triggering the switch to power, and thereby activate, the sensor system. In this mode, the sensor system is primed to respond to axial displacement of the first member 16 relatively to the second member 17.

Once fully inserted, the first anchor 24 and the second anchor 38 engage the rock hole 18 at a proximal anchor point 46 and a distal anchor point 48, respectively.

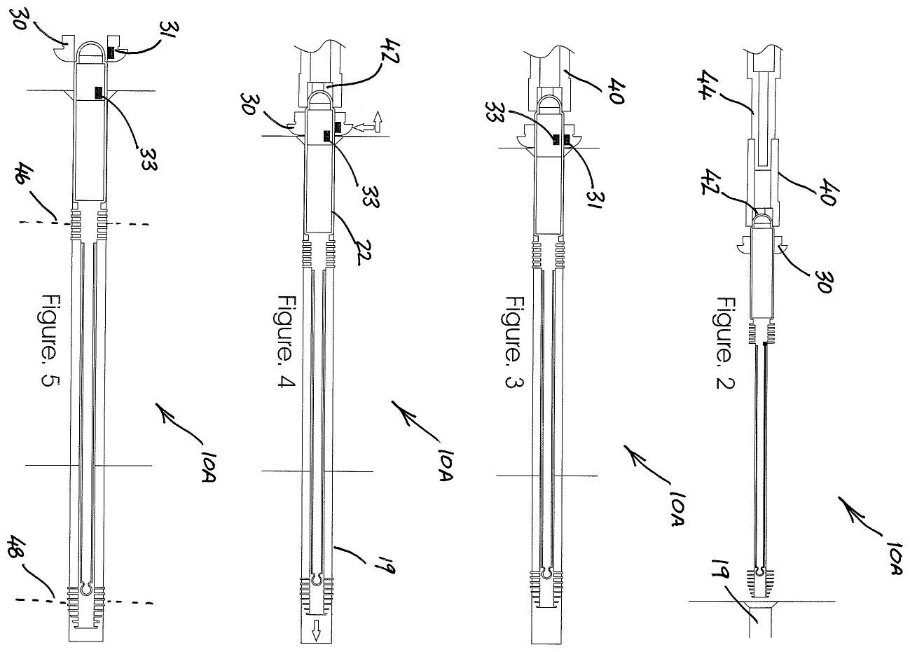

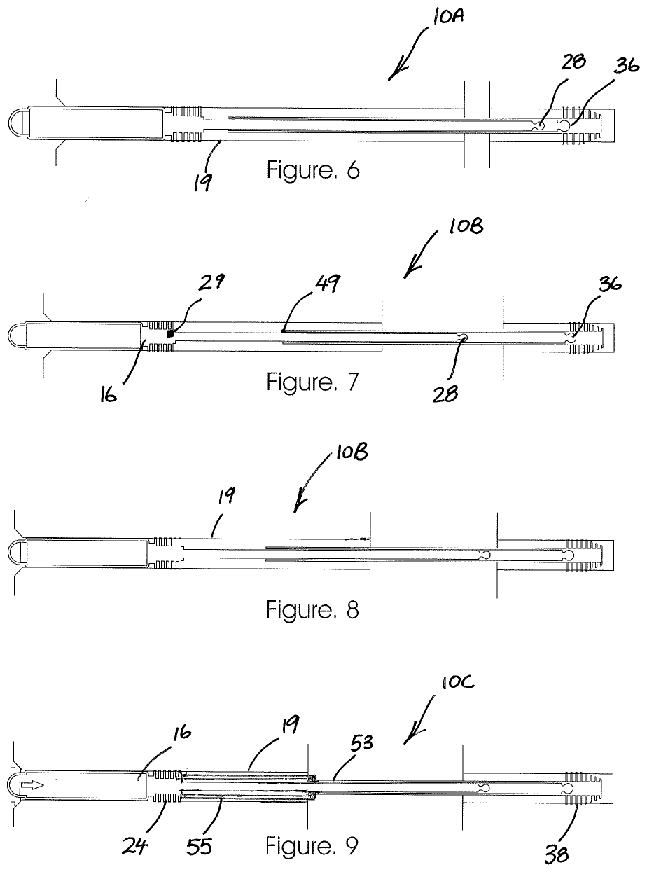

When rock separation occurs, between the proximal and distal locations, as progressively illustrated in FIGS. 6, 7 and 8, the interfacing pin 28 disengages the blind end 36 as the first member 16 moves axially away from the second member 17. However, the anchors keep the respective member (16, 17) anchored to the respective proximal and distal anchor points (46, 48).

This movement is proportional to the displacement within the rock hole and the first member 16 is responsive to this movement. With this movement, separation of the sensor 29, mounted to the first member 16, and a target 49 on the second member 17, will occur.

FIGS. 1B and 1C illustrate variations on the first and second member configuration and, consequently, the sensor 29 and target 49 positioning. In FIG. 1B it is the second member of the device 10B that includes the shaft 18, and the first member includes the tubular section 33. In FIG. 1C, the device 10C has additional tubular sections 53 and 55, concentric with the tubular section 32, which axially extend from the distal anchor 38 and the proximal anchor 24, respectively. Each of these tubular sections (53, 55) has an outwardly and inwardly facing lip (57, 59) respectively. These lips interlock to define a maximum extension limit of the body 12, as will be further explained with reference to FIG. 9. The device 10D illustrated in FIG. 1D illustrates an alternative to the optical sensor. Here, the sensor 29 is a magnetic sensor fitted within bore 34 of the cylindrical section 32. A refence magnet 61 is positioned adjacent the outwardly facing lip 57 of tubular section 53 and, as the first and second members (16, 17) pull away from one another due to rock mass displacement, the reference magnet wipes along the sensor giving position.

As a consequence, the sensor generates a signal (a displacement output) which is communicated to the processing module 23 to calculate a measure of displacement. If this measure exceeds a predetermined maximum, the visual or audible indicator 20 and/or transmitter (not shown) is caused to emit a visual/audible warning.

It is anticipated within the scope of this invention that the transmitter can communicate this warning, and the measure, to a remote location either continuously or at intervals.

In FIG. 9, the device 10C is illustrated. As mentioned, the outwardly and inwardly facing lips (57, 59) interlock to define a maximum extension limit of the body 12, at which point the sensor system can be configured to report this. Further displacement beyond the maximum extension can pull the first member 16 further into the hole. This would ensure that the activation collar 30, if still attached at this stage, is pulled off. Both the device ingress into the hole and the collar pull-off can serve as highly noticeable visual indications of excess displacement.

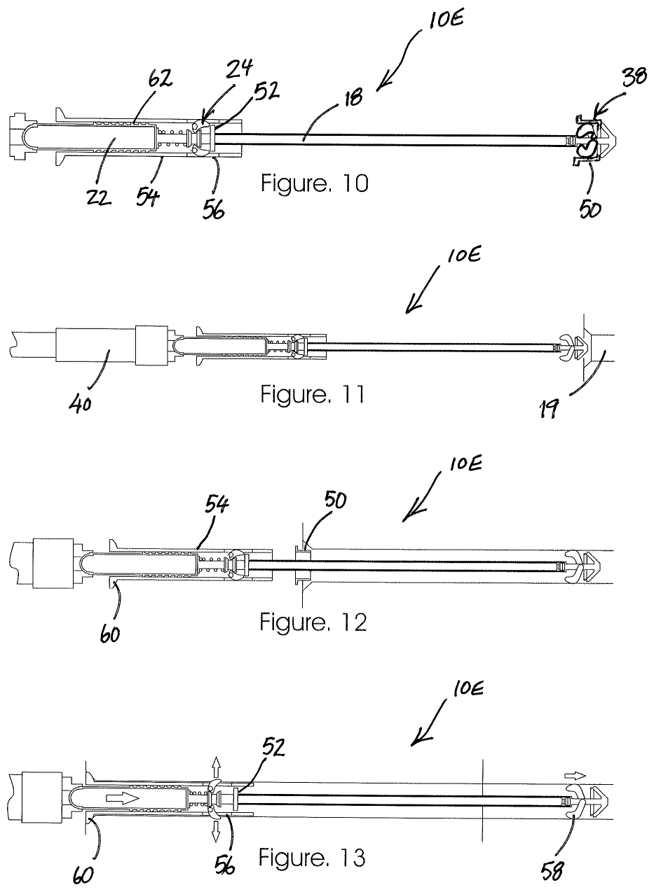

FIGS. 10 to 16 illustrate a further embodiment of the invention, a displacement measuring device 10E. In describing this embodiment, similar features are assigned like designations. Moreover, for ease of illustration and description, only the features that are different to the preceding embodiment are described with detail.

This embodiment differs essentially with the first embodiment 10A in that each anchor (24, 38) is a mechanical radially expansible anchor.

In order to keep each of these anchors in a closed configuration, prior to deployment, the device 10E includes a cap 50, which restrains the second anchor 38, and a restraining mechanism 52, which restrains the first anchor 24. The device 10B also includes a tubular sleeve 54.

A part of the housing 22, the first anchor 24 and a proximal portion of the shaft 18 is contained within the sleeve. The sleeve has openings (slots) 56 through which the first anchor can radially expand.

FIG. 11 illustrates device 10E engaged with the installation tool 40 about to be pushed into the rock hole 19. As the device enters the rock hole, the cap 50 is held back at the entrance to the hole and falls away (see FIG. 12). This allows the second anchor 38 to activate into radial expansion. However, the inward movement of the device is not impinged by this radial expansion as the sprung cams or fingers 58 of the anchor bias inwardly allowing for axial progression of the device into the hole.

As illustrated in FIG. 13, the device 10E is inserted into the rock hole until a collar 60 of the sleeve 54 engages with a mouth of the rock hole. With the sleeve held back by this engagement, further inward movement will cause the first member 24 to move relatively to the sleeve, with the housing moving against one-way serrations 62 on an inside wall of the sleeve. This action initiates the sensor system to start responding to axial displacement of the first member relatively to the second member 17.

The first anchor 24 is affixed in a manner that permits it to move along the shaft 18, facilitating relative motion. Consequently, as the forward motion occurs, the restraining mechanism 52 shifts its position, creating distance between itself and the first anchor 24, enabling the anchor to deploy radially through the openings 56 situated at the proximal location 46.

An installation spring 64, disposed between the housing 22 and the first anchor, compresses as the first member 24 moves forward (see FIG. 13), preloading the device 10E and ensuring that the first anchor 24 does not retract. Simultaneously, the second anchor 38 fixes the device 10E at the distal location. FIG. 13 illustrates this.

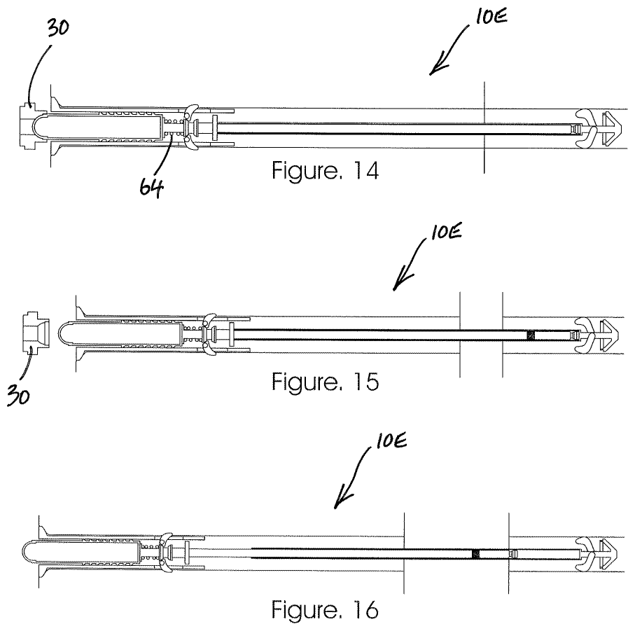

As with the earlier embodiment, when rock separation occurs, as progressively illustrated in FIGS. 14 to 16, the first member 16 moves axially relatively to the second member 17, as the anchors keep the respective member (16, 17) anchored to the proximal and distal location (46, 48) respectively. This relative axial movement is detected, measured, and communicated as described with respect to device 10A.

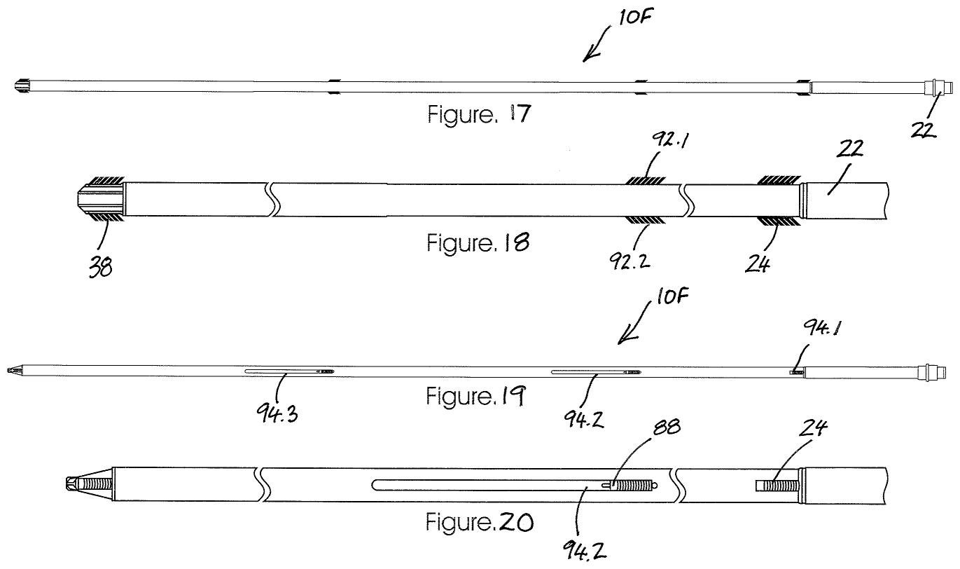

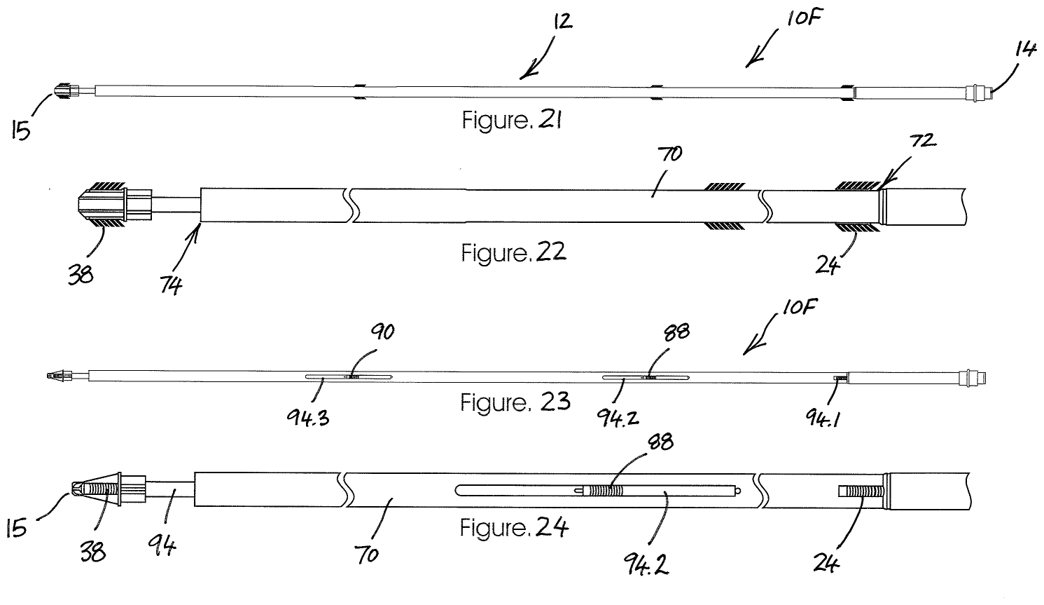

FIGS. 17 to 28 illustrate a displacement measuring and displacement locating device 10F in accordance with another embodiment the invention. What distinguishes this embodiment over the preceding embodiments is that this device is not only adapted to measure rock separation displacement or deformation of a rock mass surrounding a rock hole, in which the device is installed, but also to identify where along the rock hole this displacement is occurring.

In describing this embodiment, analogous features bear like designations.

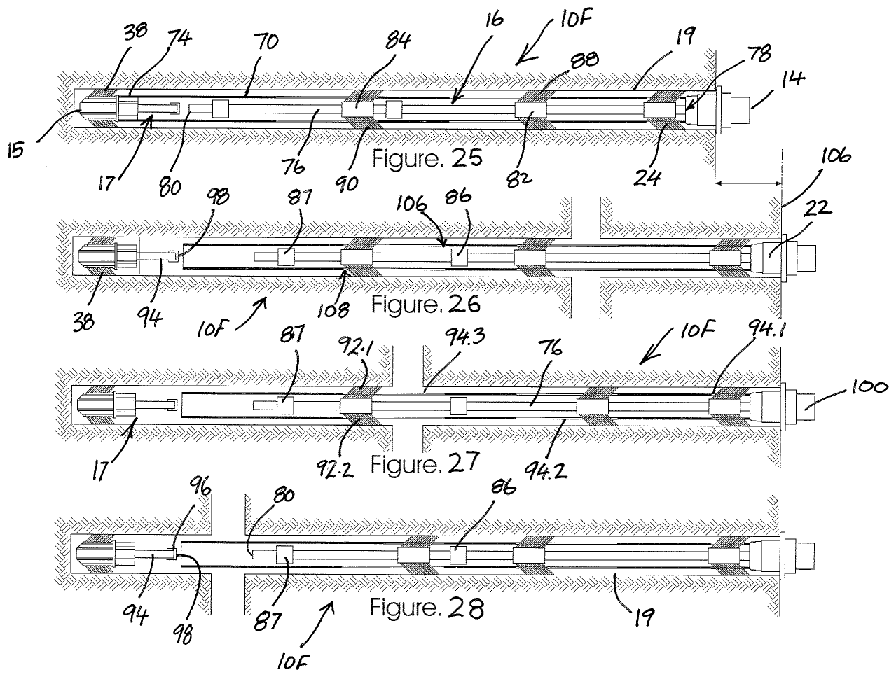

The device 10F includes a rigid elongate body 12 which extends between a proximal end 14 and a distal end 15 and which is adapted for insertion, by suitable mechanised means, in a rock hole 19 (see FIGS. 25 to 28).

The body 12 includes a first member 16 and a second member 17. These members are at least partially encased with a cylindrical sleeve 70 which extends between a trailing end 72 and a leading end 74. The second member 17 is hereinafter referred to as a distally locating element.

The first member 16 includes a guide rod 76 co-axially positioned within the sleeve, which rod extends between a first end 78 and a second end 80.

The electronic component housing 22 is engaged to a proximal end 72 of the sleeve and the first end 78 of the rod.

Within the sleeve, and mounted to the guide rod 28, the device 10F includes a first cylindrical sliding member 82 and a second cylindrical sliding member 84 positioned between the first member and a second end 80 of the rod. Each of these members is cylindrical in form, moveable within the sleeve, along the guide rod.

The device 10F has two optical sensors, which sense the location of the displacement and the magnitude of the displacement, fixedly mounted on the guide rod: a first sensor 86 located between the sliding members (82, 84) and a second sensor 87 mounted adjacent the guide rod second end 80.

The device 10F has four static (resistive and resiliently deformable) anchors: a proximal anchor 24 fixedly mounted to the guide rod 76 towards its first end 30, a distal anchor 38 on the distally locating element 17, a first intermediate anchor 88 engaged to the first sliding member 82, and a second intermediate anchor 90 engaged to the second sliding member 84.

For the proximal anchor 24, and the intermediate anchors (88, 90) to engage the walls of the rock hole 19 when deployed, a pair of diametrically opposed fin-sets (92.1, 92.2) of each anchor penetrate a respective slot of a plurality of slot-pairs (respectively designated 94.1, 94.2, 94.3) formed through the sleeve. The slots are best illustrated in FIGS. 20 and 24.

To accommodate the relative movement of the intermediate anchors (84, 88), relatively to the sleeve, the slots (94.2 and 94.3) are elongate.

The distally locating element 17 includes a stem 94 which projects from the element in a direction which is coaxial with the guide rod 76. An end 96 of the stem is positioned opposed the second end 80 of guide rod, with a relatively small gap between these ends, when the device 10F is in a pre-displacement configuration. This configuration is illustrated in FIG. 25. A sensor target 98 is located at the end of the stem.

In this pre-displacement configuration, the distally locating element 17 is engaged with the leading end 74 of the sleeve 70.

The housing 22 contains a processing module, a power source and, optionally, an indicator (not shown in the corresponding Figures). The two sensors (86, 87) are in electronic communication with the processing module.

An installation adapter 100 attaches to a projecting end of the housing which adapts the device 10F for mechanised installation by being complementarily configured to engage a rock drill of an installation rig.

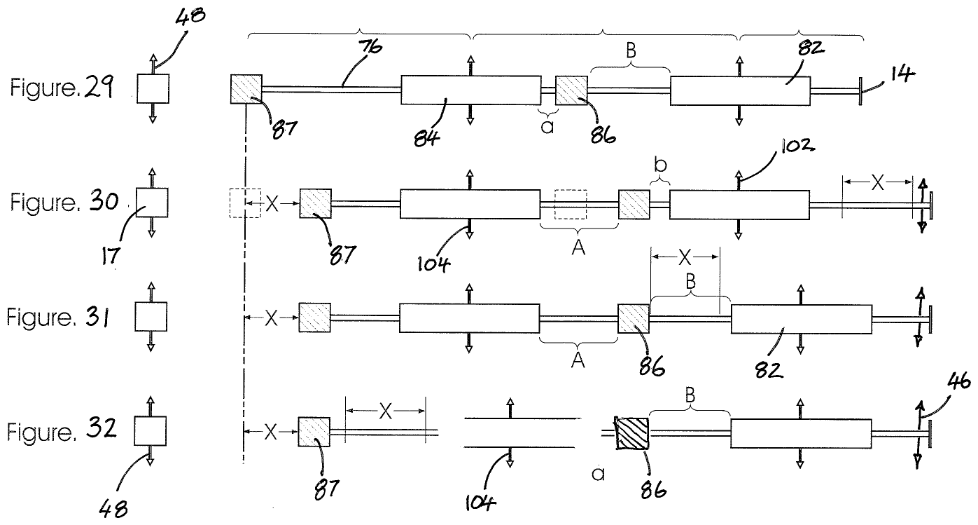

FIG. 25 illustrates the displacement measuring displacement locating device 10F fully inserted in the rock hole 19 in a pre-displacement configuration. No deployed, each of the anchors (24, 38, 88 and 90) engage, and anchor the device to, the walls of the rock hole at a proximal location 46, a distal location 48, a first intermediate location 102 and a second intermediate location 104 respectively (see FIG. 30).

The movement of the rock mass, causing a separation, moves the rock face 106 outwardly, pulling on the housing 22 and the attached sleeve 70 and guide rod 76. With the distally locating element 17 anchored in position at the distal location 48 by the distal anchor 38, the pulling away of the sleeve separates the sleeve from the distally locating element as illustrated in FIGS. 26, 27 and 28.

However, as the first and second sliding members (82, 84) are fixed in position to the first and the second intermediate locations (102, 104) by the first and second intermediate anchors (88, 90), the sleeve and the guide rod will move outwardly relatively to these members. In so doing, the second sensor 87 moves away from the sensor target 98.

This relative movement is facilitated by the movement of the fin-sets (92.1, 92.2) of the respective anchors moving within the respective slots (94.2, 94.3) from a back end 106 of each slot to a forward end 108 of each slot. This is illustrated in FIG. 26.

This configurational movement within the device 10F is proportional to the displacement within the rock hole and the second optical sensor 87, targeting off the sensor target 98, will sense this movement and generate a signal which will be communicated to the processing module for translation into a measure of the magnitude of the displacement. This measure may be communicated to the visual or audible indicator (if the measure exceeds a predetermined maximum) and/or transmitter (to communicate the measure continuously or at intervals).

Whilst the second sensor 87 is instrumental in calculating the aggregate displacement (which in this example 8 are all of the same magnitude as illustrated in FIGS. 26, 27 and 28), the first sensor 86 is instrumental in determining where, along the rock hole 19, this displacement is occurring. The first sensor does this by sensing the movement of the first and the second sliding members (82, 84) relatively to it.

In FIG. 26, rock separation is exemplified by occurring between the distal location 46 and the first intermediate location 102 (hereinafter “first quarter”). In this example, with the first sensor 86 fixed to the guide rod 28, and the members (82, 84) anchored to the rock hole wall in the first and the second intermediate locations (102, 104), the first sensor 86 will move away from member 104 (to open a spacing from a to A) towards member 82 (to close a spacing from B to b). This relative movement is diagrammatically illustrated in FIG. 30.

In FIG. 27, rock separation is exemplified by occurring between the first intermediate location 102 and the second intermediate anchor 104 (hereinafter “second quarter”). In this example, the second member will remain anchored to the second intermediate location 104. However, the first intermediate location 102, as part of the rock mass on the rock face side of the separation zone, will move with this rock mass away from the second intermediate location. The first member 82, anchored to the first intermediate location, will not move relatively to the sleeve and to the guide rod. Therefore, the first sensor 86 will move away from member 82 (to open up a spacing from a to A), but the original installation spacing (designated B) between this sensor and the member 82 remains the same. See FIG. 31 which diagrammatically illustrates this relative movement.

In FIG. 28, rock separation is exemplified by occurring between the distal location 48 and the second intermediate location 104 (hereinafter “third quarter”). In this example, with the rock mass containing both the first and the second intermediate locations (102, 104) on the rock face side of the separation zone, both the first and second members (82, 84), anchored as they are to the first and second intermediate locations, will not move relatively to the sleeve and to the guide rod. Therefore, the original spacing between the first sensor 86, and member 84 (designated a), and member 82 (designated B), remains the same.

Hence, when the processing module receives a signal (output) from the first sensor 86 indicating the following:
an increase in the distance from “a” to “A” and a decrease in the distance from “B” to “b,” it will conclude that the displacement is happening in the first quarter;
an increase in the distance from “a” to “A” while maintaining the distance at “B,” it will deduce that the displacement is occurring in the second quarter;
when both the distances “a” and “B” remain constant, the module will deduce that the displacement is happening in the third quarter.

1. A displacement measuring device which includes an elongate rigid body which extends between a proximal end and a distal end and which is adapted for insertion in a rock hole, the body including a first member and a second member, a proximal anchor engaged with the first member, adapted to engage the rock hole at a proximal location, a distal anchor engaged with the second member, adapted to engage the rock hole at a distal location, and a displacement sensor, wherein the first member is adapted to move axially relatively to the second member when the proximal location moves away from the distal location, as a result of a displacement, and wherein the displacement sensor is responsive to movement of the first member relatively to the second member and which is adapted to generate a first output which is indicative of the extent of the displacement.

2. A displacement measuring device according to claim 1 wherein the first member is directly engaged to the second member.

3. A displacement measuring device according to claim 2 wherein the first and second members are telescopically inter-engaged.

4. A displacement measuring device according to claim 2 wherein the first member or the second member includes a cylinder with a bore.

5. A displacement measuring device according to claim 4 wherein the second member or the first member includes a shaft which engages with the bore.

6. A displacement measuring device according to claim 1 wherein the first member and the second member are not directly engaged.

7. A displacement measuring device according to claim 6 which includes at least one sleeve which connects the first and second members.

8. A displacement measuring device according to claim 7 wherein the at least one sleeve contains, at least partially, the first and second members.

9. A displacement measuring device according to claim 7 wherein the at least one sleeve is a cylindrical sleeve which includes a plurality of slots longitudinally spaced from one another.

10. A displacement measuring device according to claim 9 wherein the first member includes a guide rod to which the proximal anchor engages.

11. A displacement measuring device according to claim 10 which includes a plurality of spaced intermediate anchor elements mounted on the guide rod, each anchor element positioned to penetrate the at least one sleeve through a respective slot, and each anchor element adapted to move relatively to the guide rod, within its slot.

12. A displacement measuring device according to claim 11 wherein the anchor elements are static anchors, and the proximal and distal anchors are static or active anchors.

13. A displacement measuring device according to claim 12 which includes at least one location sensor engaged with the guide rod to move relatively to the anchor elements and which is adapted to generate a second output which is indicative of a locality of the displacement.

14. A displacement measuring device according to claim 13 wherein the at least one location sensor is responsive to the relative distance between it and the adjacent anchor elements.

15. A displacement measuring device according to claim 6 which includes a first sleeve and a second sleeve, wherein the first sleeve contains, at least partially, the first member, and wherein the second sleeve contains, at least partially, the second member.

16. A displacement measuring device according to claim 15 wherein the first and the second sleeves are adapted to hold the proximal and the second anchors, respectively, in an inactive contained position.

17. A displacement measuring device according to claim 16 wherein the first and second sleeves move relatively to the respective first and second members, enabling the first and second anchors to reconfigure from the contained position to an expanded position.

18. A displacement measuring device according to claim 13 wherein the displacement sensor or the at least one location sensor is a resistive or capacitive potentiometer, a linear encoder, a string potentiometer, an optical or infrared sensor, a time-of-flight sensor, an ultrasonic sensor, or a hybrid sensor, for example, a spring elongating against a load cell or a magnetic-resistive potentiometer displacement sensor.

19. A displacement measuring device according to claim 18 wherein the displacement sensor and the at least one location sensor are optical sensors.

20. A displacement measuring device according to claim 18 wherein the displacement sensor is located on the either the first member or the second member, with a reference correspondingly located on either the second member or first member.

21. A displacement measuring device according to claim 18 which includes a processing module which is in communication with the displacement sensor to receive the first output to calculate the extent of the displacement, and which is in communication with the at least one location sensor to receive the second output to determine the locality of the displacement.

22. A displacement measuring device according to claim 21 which includes an activation mechanism which initiates the displacement sensor to start responding to the displacement.

23. A displacement measuring device according to claim 22 wherein the first member includes a housing which contains the processing module.

24. A displacement measuring device according to claim 23 wherein the activation mechanism includes a first moveable part, which includes a reference element, which engages the housing, and a switch contained with the housing, and which is in communication with the processing module.

25. A displacement measuring device according to claim 24 wherein the first moveable part is adapted to contain the reference element, and to resiliently engage the housing and to slide off the housing as a result of the displacement.

26. A displacement measuring device according to claim 24 wherein the reference element is a magnet, and the switch is a magnetic switch.

27. A displacement measuring device according to claim 21 wherein the processing module is in communication with the at least one location sensor to receive the second output to determine the locality of the displacement.

28. A displacement measuring device according to claim 21 which includes an indicator which is in communication with the processing module, and which is caused to emit a signal in response to the displacement exceeding a predefined limit.

29. A displacement measuring device according to claim 28 wherein the indicator is located at the proximal end.

30. A displacement measuring device according to claim 1 wherein the proximal end is adapted for engagement or connection with a drill rig rock drill or other specialised bolting equipment.
